(19) United States
(12) Patent Application Publication
(10) Pub. No.: US 2008/0249242 A1
(43) Pub. Date: Oct. 9, 2008

(54) Aqueous Vinyl Graft Copolymer Compositions

(75) Inventors: Saskia Carolien Van Der Slot, Waalwijk (NL); Tijs Nabuurs, Waalwijk (NL); Gerardus Cornelis Overbeek, Waalwijk (NL)

Correspondence Address: NIXON & VANDERHYE, PC, 901 NORTH GLEBE ROAD, 11TH FLOOR, ARLINGTON, VA, 22203, US

(73) Assignee: DSM IP Assets B.V., TE Heerlen (NL)

(21) Appl. No.: 12/066,537

(22) PCT Filed: Sep. 13, 2006
(86) PCT No.: PCT/EP06/08909

§ 371 Date: Jun. 6, 2008

(30) Foreign Application Priority Data
Sep. 30, 2005 (EP) 05109074.4

(51) Int. Cl. C08L 51/06

(52) U.S. Cl. 525/70

(57) ABSTRACT

An aqueous composition comprising at least one vinyl graft copolymer (A) and at least one vinyl polymer (B) obtained by a process comprising steps a) polymerising at least one vinyl monomer to obtain at least one macromonomer with a Tg¹>15° C.; b) polymerising at least one vinyl monomer in the presence of the macromonomer prepared in step a) to form a polymeric backbone of said vinyl graft copolymer (A); c) polymerising at least one vinyl monomer in the presence of the vinyl graft copolymer (A) prepared in step b), to form said vinyl polymer (B); and where vinyl polymer (B) has a Tg² lower than the Tg¹ of the macromonomer.

The present invention relates to certain aqueous vinyl graft copolymer compositions, to a process for the production of such aqueous vinyl graft copolymer compositions and to their use.

The use of aqueous vinyl polymer compositions is well known in the art for numerous applications, and in particular for the provision of a binder material in coating applications. It is also known to be advantageous in some coating applications to employ an aqueous vinyl polymer composition containing a blend of a vinyl graft copolymer and a polymer.

In coating applications such as for example water-borne printing inks, overprint lacquer formulations, paper and film coatings; used in particular in the graphic arts industry, there is a need for the aqueous composition or the resulting coating to have a combination of properties. These include the capability of having a high polymer solids content (to reduce drying times), a good low minimum film forming temperature (MFFT) and a viscosity acceptable for the application.

The use of aqueous vinyl polymer compositions in adhesive compositions are also well known in the art. Examples of adhesives include contact adhesives, pressure sensitive adhesives and laminating adhesives.

Adhesive compositions require a combination of properties, in particular tack, peel strength and shear resistance. Tack generally relates to the initial attraction of an adhesive to a substrate, peel strength generally relates to the measure of the bond strength between an adhesive and a substrate (when the peel occurs at an angle of about 180°) and the shear resistance generally relates to the internal strength of the adhesive (when separation occurs in a longitudinal direction).

WO 02/22691 discloses an aqueous dispersion of a segmental copolymer (which may be a comb copolymer) with a hard/soft balance advantage value of at least 25%, which may contain an emulsion polymer. WO 95/04767 discloses a process for the production of an aqueous polymer emulsion where a hydrophobic polymer is prepared by emulsion polymerisation of olefinically unsaturated monomers in the presence of a low molecular weight, acid group functional polymer in a two-step process. U.S. Pat. No. 5,770,646 discloses a blend of branched polymer dispersant prepared by solvent polymerisation and a hydrophobic material. U.S. Pat. No. 5,981,642 discloses a method of grafting a preformed oligomer to a preformed polymer. WO02/22755 discloses aqueous adhesive compositions comprising water insoluble graft copolymers with 1 to 30 wt % of macromonomers and WO02/22734 discloses a composition comprising graft copolymers with 30 to 60 wt % of a graft segment for use in an extrusion process.

We have now discovered how to prepare aqueous vinyl graft copolymer compositions where the mechanical and physical properties such as for example viscosity, adhesion, crosslinkability and minimum film forming temperatures are easily tailorable.

It is known to the skilled person that when preparing aqueous polymer compositions containing a significant amount of material with a low Tg, excessive reactor fouling is often observed. This is particularly noticeable in the preparation of polymer compositions that show a high tack at room temperature (such as, for example, adhesive compositions). We have also found surprisingly that the vinyl graft copolymer compositions of the invention have a significantly reduced amount of reactor fouling.

According to the present invention there is provided an aqueous composition comprising at least one vinyl graft copolymer (A) and at least one vinyl polymer (B) obtained by a process comprising steps:
a) polymerising at least one vinyl monomer to obtain at least one macromonomer with a Tg¹≧15° C.;
b) polymerising i) 60 to 5 wt % of at least one vinyl monomer in the presence of ii) 40 to 95 wt % of the macromonomer prepared in step a) to form a polymeric backbone of said vinyl graft copolymer (A) and where i) and ii) add up to 100%;
c) polymerising iii) 95 to 50 wt % of at least one vinyl monomer in the presence of iv) 5 to 50 wt % of the vinyl graft copolymer (A) prepared in step b), to form said vinyl polymer (B);
   where iii) and iv) add up to 100%; and
   where vinyl polymer (B) has a Tg² lower than the Tg¹ of the macromonomer.

The Tg of a polymer herein stands for the glass transition temperature and is well known to be the temperature at which a polymer changes from a glassy, brittle state to a rubbery state. Tg values of polymers may be determined experimentally using techniques such as differential scanning calorimetry DSC or calculated using the well-known Fox equation.

The macromonomer, vinyl graft copolymer (A) and vinyl polymer (B) are derived from free-radically polymerisable olefinically unsaturated monomers, which are also usually referred to as vinyl monomers, and can contain polymerised units of a wide range of such monomers, especially those commonly used to make binders for the coatings industry.

Examples of vinyl monomers which may be used to form the macromonomer, vinyl graft copolymer (A) and vinyl polymer (B) include but are not limited to olefinically polyunsaturated monomers such as 1,3-butadiene, isoprene; polyalkylene glycol di(meth)acrylates such as 1,3-butyleneglycol diacrylate, ethylene glycol diacrylate; divinyl benzene; styrene, α-methyl styrene, (meth)acrylic amides and (meth)acrylonitrile; vinyl halides such as vinyl chloride; vinylidene halides such as vinylidene chloride; vinyl ethers; vinyl esters such as vinyl acetate, vinyl propionate, vinyl laurate and vinyl esters of versatic acid such as VeoVa 9 and VeoVa 10 (VeoVa is a trademark of Resolution); heterocyclic vinyl compounds; alkyl esters of mono-olefinically unsaturated dicarboxylic acids such as di-n-butyl maleate and di-n-butyl fumarate and, in particular, esters of acrylic acid and methacrylic acid of formula CH₂═CR¹—COOR² wherein R¹ is H or methyl and R² is optionally substituted alkyl or cycloalkyl of 1 to 20 carbon atoms (more preferably 1 to 8 carbon atoms) examples of which are methyl(meth)acrylate, ethyl(meth)acrylate, butyl(meth)acrylate (all isomers), octyl (meth)acrylate (all isomers), 2-ethylhexyl(meth)acrylate, isopropyl(meth)acrylate, n-propyl(meth)acrylate, and hydroxyalkyl(meth)acrylates such as hydroxyethyl(meth)acrylate, 2-hydroxypropyl(meth)acrylate, 4-hydroxybutyl (meth)acrylate and their modified analogues like Tone M-100 (Tone is a trademark of Union Carbide Corporation). Monomers of formula CH₂═CR¹—COOR² when R¹═H are usually known as acrylate monomers and when R¹=methyl are usually known as methacrylate monomers.

The vinyl monomers may include vinyl monomers carrying functional groups such as crosslinker groups and/or hydrophilic water-dispersing groups and/or other functional vinyl monomers as exemplified below. Such functionality may be introduced directly in the vinyl graft copolymer by free radical polymerisation, or alternatively the functional group may be introduced by a reaction of a reactive vinyl monomer, which is subsequently reacted with a reactive compound carrying the desired functional group. Some functional groups may perform more than one function, for example (meth)acrylic acid is usually used as a water-dispersing monomer however it may also act as a crosslinking monomer. Such variations are known to those skilled in the art.

Water-dispersing groups provide the facility of self-dispersibility, stability, solubility in water and/or wettability of substrate or pigment. The water-dispersing groups may be ionic, potentially ionic, non-ionic or a mixture of such water-dispersing groups. Ionic water-dispersing groups need to be in their dissociated (i.e. salt) form to effect their water-dispersing action. If they are not dissociated they are considered as potential ionic groups, which become ionic upon dissociation. The ionic water-dispersing groups are preferably fully or partially in the form of a salt in the final composition of the invention. Ionic water-dispersing groups include cationic water-dispersing groups such as basic amine groups, quaternary ammonium groups and anionic water-dispersing groups such as acid groups, for example phosphoric acid groups, sulphonic acid groups and carboxylic acid groups. Conversion to the salt form is described below.

Preferred vinyl monomers providing anionic or potentially anionic water-dispersing groups include (meth)acrylic acid, itaconic acid, maleic acid, β-carboxyethyl acrylate, monoalkyl maleates (for example monomethyl maleate and monoethyl maleate), citraconic acid, styrene sulphonic acid, vinylbenzylsulphonic acid, vinylsulphonic acid, acryloyloxyalkyl sulphonic acids (for example acryloyloxymethyl sulphonic acid), 2-acrylamido-2-alkylalkane sulphonic acids (for example 2-acrylamido-2-methylethanesulphonic acid), 2-methacrylamido-2-alkylalkane sulphonic acids (for example 2-methacrylamido-2-methylethanesulphonic acid), mono-(acryloyloxyalkyl)phosphates (for example, mono(acryloyloxyethyl)phosphate and mono(3-acryloyloxypropyl)phosphates) and mono(methacryloyloxyalkyl)phosphates (for example mono(methacryloyloxyethyl)phosphate).

Non-ionic water-dispersing groups may be in-chain, pendant or terminal groups. Preferably non-ionic water-dispersing groups are pendant polyoxyalkylene groups, more preferably polyoxyethylene groups. Preferred vinyl monomers providing non-ionic water-dispersing groups include alkoxy polyethylene glycol(meth)acrylates, hydroxy polyethylene glycol(meth)acrylates, alkoxy polypropylene glycol(meth)acrylates and hydroxy polypropylene glycol(meth)acrylates, preferably having a number average molecular weight of from 350 to 3000. Examples of such monomers which are commercially available include ω-methoxypolyethylene glycol(meth)acrylate. Other vinyl monomers providing non-ionic water-dispersing groups include (meth)acrylamide.

Vinyl graft copolymer (A) and/or vinyl polymer (B) may possess functional groups for imparting latent crosslinkability to the composition (so that crosslinking takes place for example after the aqueous composition is subsequently dried) either when combined with a crosslinking agent or by reaction with each other. Vinyl graft copolymer (A) may be combined with a crosslinking agent after the preparation of vinyl graft copolymer (A) and/or after the preparation of vinyl polymer (B), said crosslinking agent being reactable with the crosslinkable groups on the vinyl graft copolymer (A) and (if present) on the vinyl polymer (B) on subsequent drying of the composition to effect crosslinking. For example, one or both of vinyl graft copolymer (A) and/or vinyl polymer (B) could carry functional groups such as hydroxyl groups and the composition is subsequently formulated with a crosslinking agent such as a polyisocyanate, melamine, or glycoluril; or the functional groups on one or both polymers could include keto, aldehyde and/or acetoacetoxy carbonyl groups and the subsequently formulated crosslinker could be a polyamine or polyhydrazide such as adipic acid dihydrazide, oxalic acid dihydrazide, phthalic acid dihydrazide, terephthalic acid dihydrazide, isophorone diamine and 4,7-dioxadecane-1,10-diamine; or a crosslinker carrying semi-carbazide or hydrazine functional groups. Alternatively the polymer could contain hydrazide functional groups and the subsequently formulated crosslinker could contain keto functional groups. An example of a hydrazide group functional molecule is where it is obtained through a hydrazinolysis reaction where an ester group functional molecule is reacted with hydrazine to give a hydrazide functional molecule, which then can react with a keto functional molecule. The functional groups on one or both polymers could include carboxyl functional groups and the subsequently formulated crosslinker could comprise aziridine, epoxy or carbodiimide functional groups. The functional groups on one or both polymers could include silane functional groups and the subsequently formulated crosslinker could comprise silane functional groups.

Vinyl monomers carrying crosslinker groups include for example allyl, glycidyl or hydroxyalkyl(meth)acrylates, acetoacetoxy esters, acetoacetoxy amides, keto and aldehyde functional vinyl monomers, keto-containing amides such as diacetone acrylamide, methylol and silane functional (meth)acrylic monomers.

Preferred vinyl monomers carrying crosslinker groups are diacetone acrylamide, acetoacetoxy ethyl methacrylate (AAEM) and silane functional (meth)acrylic monomers. Examples include Silquest A-2171, Silquest A-174, CoatOSil 1757, Silquest A-151 and Silquest A-171 available from OSI Specialty Chemicals (Silquest and CoatOSil are trademarks). Also possible are combinations of AAEM and amine functional silanes such as Silquest A-1100 or A-1101 or combinations of acid functional vinyl monomers and epoxy functional silanes such as Silquest A-186 or A-187.

The vinyl graft copolymer (A) and vinyl polymer (B) may optionally contain other functional groups to contribute to optional crosslinking. Examples of such other groups include unsaturated groups such as those provided by maleic, fumaric, acryloyl, methacryloyl, styrenic, allylic and mercapto groups, these allow crosslinking through Michael Addition by using polyamines or UV crosslinkability to be introduced into the vinyl graft copolymer (A).

Preferred crosslinking mechanisms include silane functional group crosslinking and keto functional group with hydrazide functional group crosslinking.

The vinyl graft copolymer (A) may comprise functional vinyl monomers that act as adhesion promoters, such as Sipomer WAM (ex. Rhodia), Cylink C4 (ex. Cytec), and Norsocryl 104 (ex. Atofina), or monomers with long alkyl chains, such as lauryl(meth)acrylate, and stearyl(meth)acrylate or adhesion promoters such as β-napthyl methacrylate.

The term macromonomer as used in the present invention is defined as a low molecular weight vinyl polymer with a terminal unsaturated group. The term macromonomer as used herein includes one macromonomer as well as more than one macromonomer.

Preferably the weight average molecular weight of the macromonomer is in the range of from 2,000 to 200,000 g/mol, more preferably 2,000 to 150,000 g/mol and most preferably 2,000 to 100,000 g/mol.

Preferably the macromonomer comprises at least 50% of methacrylate monomers.

Preferably the macromonomer comprises 0 to 60 wt %, more preferably 0 to 45 wt %, most preferably 0 to 30 wt % and especially 0 to 22.5 wt % of vinyl monomers carrying water-dispersing groups.

If the macromonomer comprises vinyl monomers carrying anionic or potentially anionic water-dispersing groups then preferably the acid value of the macromonomer is in the range of from 0 to 350, more preferably 0 to 90, most preferably 0 to 50 and especially 0 to 40 mgKOH/g.

Preferably the macromonomer comprises 0 to 30 wt %, more preferably 0 to 15 wt % and most preferably 2 to 8 wt % of vinyl monomers carrying non-ionic water-dispersing groups.

Preferably the macromonomer comprises 0 to 30 wt % and more preferably 2 to 10 wt % of vinyl monomers carrying crosslinker groups.

Preferably the macromonomer comprises 0 to 30 wt %, more preferably 0.5 to 10 wt % and most preferably 1 to 5 wt % of vinyl monomers that act as adhesion promoters.

Preferably the weight average molecular weight of the vinyl graft copolymer (A) is ≧100,000 g/mol, more preferably ≧200,000 g/mol and especially ≧300,000 g/mol.

The vinyl graft copolymer (A) comprises the macromonomer and a polymeric backbone made up of the vinyl monomers polymerised in the presence of the macromonomer. The weight % ratio of polymeric backbone to macromonomer is preferably between 50:50 to 5:95 and more preferably between 40:60 to 5:95 and especially 30:70 to 8:92.

The macromonomer and polymeric backbone may have the same or essentially the same monomer composition. The macromonomer and polymeric backbone preferably have different monomer compositions.

There is preferably a difference in the calculated Tg (calculated using the Fox equation) between the Tg¹ of the macromonomer and Tg³ of the polymeric backbone. Preferably the difference, Tg¹−Tg³ is ≧20° C. and especially ≧50° C. The polymeric backbone preferably has a Tg³ of not higher than 35° C., more preferably not higher than 20° C. and most preferably has a Tg³ below 0° C. The macromonomer preferably has a Tg¹ higher than 20° C., more preferably higher than 50° C. and most preferably higher than 65° C.

If the vinyl graft copolymer (A) comprises monomers that contribute to its acid value, these monomers may be found only in the macromonomer or only in the polymeric backbone or these monomers may be found in both the macromonomer and the polymeric backbone.

Preferably the polymeric backbone comprises at least 30 wt %, more preferably at least 40 wt % and most preferably at least 50 wt % of acrylate monomers (as exemplified above).

Preferably the polymeric backbone has an acid value in the range of from 0 to 80 and more preferably 10 to 40 mgKOH/g.

Preferably the polymeric backbone comprises 0 to 30 wt %, more preferably 0 to 15 wt % and most preferably 2 to 8 wt % of vinyl monomers carrying non-ionic water-dispersing groups.

Preferably the acid value of vinyl graft copolymer (A) is ≦160 mgKOH/g, more preferably in the range of from 0 to 75 and especially 0 to 40 mgKOH/g.

Preferably the polymeric backbone comprises 0 to 30 wt % and more preferably 2 to 10 wt % of vinyl monomers carrying crosslinker groups.

Improved adhesion in a coating may be obtained by the reaction of any carboxylic acid groups in the vinyl graft copolymer (A) with propylene imine or ethylene imine. Such a reaction would take place after step c) was completed.

For using the composition of the invention in adhesive applications, the balance between shear resistance and tack is important. By varying the molecular weight and the molecular weight distribution of vinyl polymer (B) it is possible to influence the shear resistance and tack. The molecular weight distribution is conventionally described by the polydispersibility index (PDi). PDi is defined as the weight average molecular weight divided by the number average molecular weight (Mw/Mn).

Preferably the polydispersibility (PDi) of vinyl polymer (B) is ≧16, more preferably ≧25 and most preferably ≧50.

Preferably the weight average molecular weight of vinyl polymer (B) is ≧10,000 g/mol, more preferably ≧30,000 g/mol, most preferably ≧50,000 g/mol and is especially preferably in the range of from 100,000 to 2,000,000 g/mol.

Preferably the calculated Tg² of vinyl polymer (B) is in the range of from −80 to 35° C., more preferably −80 to 30° C. and most preferably −60 to 25° C.

Preferably the difference in Tg between the Tg² of vinyl polymer (B) and the Tg¹ of the macromonomer, Tg¹−Tg²≧15° C., more preferably ≧20° C., most preferably ≧40° C. and especially ≧60° C.

Preferably vinyl polymer (B) has an acid value of ≦25 mgKOH/g, more preferably ≦20 mgKOH/g, most preferably ≦15 mgKOH/g, especially ≦8 mgKOH/g and most especially 0 mgKOH/g.

Vinyl polymer (B) preferably comprises ≧30 wt %, more preferably ≧40 wt % and most preferably ≧50 wt % of hydrophobic vinyl monomers. Examples of such monomers include butyl(meth)acrylate, lauryl methacrylate, stearyl methacrylate, 2-ethylhexyl(meth)acrylate, VeoVa 10, VeoVa 11 and/or mixtures thereof.

Preferably vinyl polymer (B) comprises 0 to 20 wt %, more preferably 0 to 10 wt % and most preferably 1 to 6 wt % of vinyl monomers carrying crosslinker groups.

In an embodiment of the present invention vinyl polymer (B) may comprise 0.5 to 5 wt % of vinyl monomers carrying amine functional groups such as for example dimethyl amino ethyl methacrylate and t-butyl amino ethyl methacrylate.

Vinyl polymer (B) and the polymeric backbone of vinyl graft copolymer (A) may have the same or essentially the same monomer composition. Alternatively vinyl polymer (B) and the polymeric backbone of vinyl graft copolymer may have a different monomer composition.

The ratio of vinyl graft copolymer (A) to vinyl polymer (B) is preferably in the range of from 45:55 to 5:95, more preferably in the range of 40:60 to 5:95 and most preferably in the range of from 25:75 to 5:95.

The macromonomer, vinyl graft copolymer (A) and vinyl polymer (B) are preferably prepared by free-radical polymerisation, although in some circumstances anionic polymerisation may be utilised. The free-radical polymerisation for preparing the macromonomer and vinyl graft copolymer (A) can be performed by techniques well known in the art, for example, emulsion polymerisation, solution polymerisation, suspension polymerisation or bulk polymerisation. If solution or bulk polymerisation is used, the polymerisation process is preferably followed by dispersion of the resultant polymer in water. Preferably vinyl polymer (B) is prepared by emulsion or suspension polymerisation. Furthermore the free-radical polymerisation may be carried out as a batch, step-wise or as a semi-continuous polymerisation process.

In another embodiment of the present invention there is provided a process for the preparation of an aqueous composition according to the present invention, said process comprising steps:
a) polymerising at least one vinyl monomer to obtain a macromonomer with a Tg¹≧15° C.;
b) polymerising i) 60 to 5 wt % of at least one vinyl monomer in the presence of ii) 40 to 95 wt % of the macromonomer prepared in step a) to form a polymeric backbone of said vinyl graft copolymer (A) and where i) and ii) add up to 100%;
c) polymerising iii) 95 to 50 wt % of at least one vinyl monomer in the presence of iv) 5 to 50 wt % of the vinyl graft copolymer (A) prepared in step b), to form said vinyl polymer (B);
   where iii) and iv) add up to 100%; and
   where vinyl polymer (B) has a Tg² lower than the Tg¹ of the macromonomer.

Free-radical polymerisation of vinyl monomers will require the use of a free-radical-yielding initiator to initiate the vinyl polymerisation. Suitable free-radical-yielding initiators include inorganic peroxides such as K, Na or ammonium persulphate, hydrogen peroxide, or percarbonates; organic peroxides, such as acyl peroxides including benzoyl peroxide, alkyl hydroperoxides such as t-butyl hydroperoxide and cumene hydroperoxide; dialkyl peroxides such as di-t-butyl peroxide; peroxy esters such as t-butyl perbenzoate and the like; mixtures may also be used. The peroxy compounds are in some cases advantageously used in combination with suitable reducing agents (redox systems) such as Na or K pyrosulphite or bisulphite, and iso-ascorbic acid. Metal compounds such as Fe.EDTA (EDTA is ethylene diamine tetracetic acid) may also be usefully employed as part of the redox initiator system. Azo functional initiators may also be used. Preferred azo initiators include azobis(isobutyronitrile) and 4,4′-azobis(4-cyanovaleric acid). The amount of initiator or initiator system used is conventional, e.g. within the range 0.05 to 6 wt % based on the total weight of vinyl monomers used. Preferred initiators include ammonium persulphates, sodium persulphates, potassium persulphates, azobis(isobutyronitrile) and/or 4,4′-azobis(4-cyanovaleric acid).

Molecular weight control may be provided by catalytic chain-transfer agents as described below, or may be provided by using chain-transfer agents such as mercaptans and halogenated hydrocarbons, for example mercaptans such as n-dodecylmercaptan, n-octylmercaptan, t-dodecylmercaptan, mercaptoethanol, iso-octyl thioglycolate, C₂ to C₈ mercapto carboxylic acids and esters thereof such as 3-mercaptopropionic acid and 2-mercaptopropionic acid; and halogenated hydrocarbons such as carbon tetrabromide and bromo trichloromethane.

The macromonomer is preferably prepared by emulsion polymerisation, suspension polymerisation or bulk polymerisation. The macromonomer is preferably prepared in the presence of a catalytic chain-transfer agent or by the use of diarylethene.

In an embodiment of the invention the macromonomer is prepared by the use of diarylethene. The use of diarylethene is described for example in W. Bremser et al, Prog. Org. Coatings, 45, (2002), 95, and JP3135151, DE10029802 and US2002/0013414. Examples of diarylethene include but are not limited to diphenylethene. Preferably ≦5 wt %, more preferably ≦4 wt %, especially ≦3 wt % and most esecially 0.5 to 3 wt % of diarylethene, based on the weight of vinyl monomers required for the macromonomer, is used.

In an embodiment of the invention the macromonomer, when obtained by catalytic chain-transfer polymerisation as described below, is a macromonomer of Formula (1):

CH₂═C(R³)—CH₂—[X]ₙ (1)

where R³=optionally substituted aryl, —C(O)OR⁴ or —C(O)NR⁴R⁵;
R⁴═—H, —CH₃ or optionally substituted C₁ to C₁₆ alkyl, cycloalkyl, aryl, (alkyl)aryl;
R⁵═—H, —CH₃ or optionally substituted C₁ to C₁₆ alkyl, cycloalkyl, aryl, (alkyl)aryl;
X=residue of an olefinically unsaturated monomer(s);
n=an integer in the range of from 2 to 1000.

To prepare a macromonomer a catalytic chain-transfer agent is preferably added to the free-radical polymerisation process. In catalytic chain-transfer polymerisation (CCTP) a free-radical polymerisation is carried out using a catalytic amount of a selected transition metal complex acting as a catalytic chain-transfer agent (CCTA), and in particular a selected cobalt chelate complex. For example, N. S. Enikolopyan et al, J. Polym. Chem. Ed, Vol 19, 879 (1981), discloses the use of cobalt II porphyrin complexes as chain-transfer agents in free-radical polymerisation, while U.S. Pat. No. 4,526,945 discloses the use of dioxime complexes of cobalt II for such a purpose. U.S. Pat. No. 4,680,354, EP 0,196,783, EP 0,199,436 and EP 0,788,518 describe the use of certain other types of cobalt II chelates as chain-transfer agents for the production of oligomers of olefinically unsaturated monomers by free-radical polymerisation. WO 87/03605 on the other hand claims the use of certain cobalt III chelate complexes for such a purpose, as well as the use of certain chelate complexes of other metals such as iridium and rhenium.

It is also possible to prepare a macromonomer using a free-radical-initiated aqueous emulsion polymerisation by using a hydrophobic cobalt chelate catalyst as a catalytic chain-transfer agent, a stabilising substance for the emulsion polymerisation process and a monomer feed stage where an aqueous pre-emulsified mixture comprising at least part of the cobalt chelate employed in the process, at least part of the stabilising substance employed in the process and a non-polymerisable organic solvent and/or a polymerisable olefinically unsaturated monomer in unpolymerised or at least partially polymerised form, is contacted in the reactor with monomer of the monomer feed stage at the beginning of and/or during the course of the monomer feed stage.

Preferably 0 to 100 wt ppm, more preferably ≦60 wt ppm, especially ≦35 wt ppm and most especially ≦20 wt ppm of catalytic chain-transfer agents, based on the weight of vinyl monomer required for the macromonomer, is used.

Combinations of conventional chain-transfer agents and catalytic chain-transfer agents may also be used.

In an embodiment of the invention macromonomers may also be prepared using a high temperature polymerisation process. An example of a high temperature polymerisation process is the method disclosed in U.S. Pat. No. 5,710,227, where a continuous high temperature polymerisation process is used to prepare polymers having a degree of polymerisation below 50 and having terminal unsaturation.

After the macromonomer has been formed the vinyl monomers required for the polymeric backbone are added to the macromonomer and are preferably polymerised by a free-radical emulsion polymerisation, suspension polymerisation or bulk polymerisation in the presence of a conventional initiator. More preferably the polymeric backbone is prepared by aqueous emulsion or suspension polymerisation.

The process for step b) may be carried out in a number of modes including but not limited to polymerising all of the macromonomer and vinyl monomers in one batch, pre-charging the macromonomer to a reactor and subsequently feeding in the vinyl monomers (or vice versa), feeding both the macromonomer and vinyl monomers to a reactor (optionally pre-charged with some macromonomer and or vinyl monomers), preparing a gradient morphology graft copolymer by feeding the vinyl monomers to the macromonomer which is simultaneously fed into a reactor (optionally pre-charged with some macromonomer) or continuously feeding a mixture of macromonomer and vinyl monomers into a reactor.

To prepare the polymeric backbone a chain-transfer agent as described above may be added to control the molecular weight of the polymeric backbone. Preferably ≦5 wt %, more preferably ≦3 wt % and most preferably ≦1 wt % of chain-transfer agent based on the weight of vinyl monomers required for the polymeric backbone is used.

Neutralisation may be carried out during and/or after any of steps b) and/or c). We have found that in order to optimise grafting efficiency in step b) if the level of vinyl acid monomer is ≧1 wt % in the macromonomer that it is preferable to carry out step b) at a pH≦6.5, more preferably ≦5.5 and most preferably ≦4.5.

Therefore, in another embodiment of the present invention there is provided a process comprising steps:
a) polymerising vinyl monomers comprising ≧1 wt % of vinyl monomers providing anionic water-dispersing groups to obtain a macromonomer with a Tg¹≧15° C.;
(b) polymerising i) 60 to 5 wt % of at least one vinyl monomer in the presence of ii) 40 to 95 wt % of the macromonomer prepared in step a) at a pH ≦6.5 to form a polymeric backbone of said vinyl graft copolymer (A) and where i) and ii) add up to 100%;
c) polymerising iii) 95 to 50 wt % of at least one vinyl monomer in the presence of iv) 5 to 50 wt % of the vinyl graft copolymer (A) prepared in step b), to form said vinyl polymer (B);
   where iii) and iv) add up to 100%; and
   where vinyl polymer (B) has a Tg² lower that the Tg¹ of the macromonomer.

To prepare the vinyl polymer (B), the vinyl monomers required are added to the vinyl graft copolymer (A) prepared in step b) and are preferably polymerised as described above for step b). Preferably vinyl polymer (B) is prepared by emulsion polymerisation.

The process for step c) may be carried out in a number of modes including but not limited to polymerising all of the vinyl graft copolymer (A) and vinyl monomers in one batch, pre-charging the vinyl graft polymer (A) to a reactor and subsequently feeding in the vinyl monomers, feeding both vinyl graft copolymer (A) and vinyl monomers to a reactor (optionally pre-charged with some vinyl graft copolymer (A)), preparing a gradient morphology vinyl polymer (B) by feeding the vinyl monomers to the vinyl graft copolymer (A) which is simultaneously fed into a reactor or continuously feeding a mixture of graft copolymer (A) and vinyl monomers into a reactor.

The aqueous composition of the invention may be a dispersion, emulsion or suspension of the vinyl graft copolymer (A) and vinyl polymer (B) in an aqueous carrier medium.

Surfactants can be utilised in order to assist in the dispersion of the vinyl monomers, macromonomer, vinyl graft copolymer (A) and or vinyl polymer (B) in water (even if they are self-dispersible). Suitable surfactants include but are not limited to conventional anionic, cationic and/or non-ionic surfactants and mixtures thereof such as Na, K and NH₄ salts of dialkylsulphosuccinates, Na, K and NH₄ salts of sulphated oils, Na, K and NH₄ salts of alkyl sulphonic acids, Na, K and NH₄ alkyl sulphates, alkali metal salts of sulphonic acids; fatty alcohols, ethoxylated fatty acids and/or fatty amides, and Na, K and NH₄ salts of fatty acids such as Na stearate and Na oleate. Other anionic surfactants include alkyl or (alk)aryl groups linked to sulphonic acid groups, sulphuric acid half ester groups (linked in turn to polyglycol ether groups), phosphonic acid groups, phosphoric acid analogues and phosphates or carboxylic acid groups. Cationic surfactants include alkyl or (alk)aryl groups linked to quaternary ammonium salt groups. Non-ionic surfactants include polyglycol ether compounds and preferably polyethylene oxide compounds as disclosed in “Non-Ionic Surfactants—Physical Chemistry” edited by M. J. Schick, M. Decker 1987. The amount of surfactant used is preferably 0 to 10% by weight, more preferably 0 to 5% by weight, still more preferably 0 to 3% by weight and especially 0.1 to 2% by weight based on the weight of the vinyl monomers.

The aqueous composition of the invention may contain conventional ingredients, some of which have been mentioned above; examples include pigments, dyes, emulsifiers, surfactants, plasticisers, thickeners, heat stabilisers, leveling agents, anti-cratering agents, fillers, sedimentation inhibitors, UV absorbers, antioxidants, drier salts, water-soluble and/or water-insoluble co-solvents, wetting agents, tackifiers and the like introduced at any stage of the production process or subsequently. Examples of tackifiers include terpene phenolics, rosins, rosin esters, esters of hydrogenated rosins, synthetic hydrocarbon rosins and combinations thereof. It is possible to include an amount of antimony oxide in the dispersions to enhance the fire retardant properties.

If desired the aqueous composition of the invention can be used in combination with other polymer compositions, which are not according to the invention. Examples include but are not limited to acid functional low molecular weight polymers (preferably with an acid value in the range from 50 to 300 mgKOH/g), low/high molecular weight polymer systems, polyurethanes, polyurethane-acrylates and Ropaque OP-300, Ropaque OP-96 and Ropaque Ultra which are synthetic polymer pigments (Ropaque is a trademark of Rohm & Haas).

The solids content of the aqueous composition of the invention is preferably within the range of from 20 to 60 wt % and most preferably within the range of from 30 to 50 wt %.

The aqueous composition of the present invention may be applied to a variety of substrates including wood, board, metals, glass, cloth, leather, paper, plastics, metallised plastics, foam and the like, by any conventional method including brushing, flow coating, spraying, flexo printing, gravure printing, ink-jet printing and the like, and including other graphic arts or adhesive application techniques. The aqueous carrier medium is removed by natural drying or accelerated drying (for example by applying heat) to form a coating.

Accordingly, in a further embodiment of the invention there is provided a coating, a printing ink, an overprint lacquer or an adhesive obtainable from an aqueous composition of the present invention.

The present invention is now illustrated by reference to the following examples. Unless otherwise specified, all parts, percentages and ratios are on a weight basis. The term comparative means that it is not according to the invention and is denoted with a C.

### Abbreviations Used:

AA=acrylic acid
MMA=methyl methacrylate
BMA=butyl methacrylate
MAA=methacrylic acid
BA=butyl acrylate
SLS=sodium lauryl sulphate, 30% solution in water, surfactant available from Cognis, Germany
AAEM=acetoacetoxy ethyl methacrylate
APS=ammonium persulphate
CTA=chain-transfer agent
PET=polyethylene terepthalate
50 MB-210=oriented polypropylene substrate available from Exxon Mobil
Metal=cold-rolled-steel plates available from Metavo
tBHPO=tertiary butylhydrogen peroxide
Co4-MePhBF=cobalt (II)(bis 4,4′-dimethyl benzildioxime)boron difluoride

### Preparation of Hydrophilic Oligomer HO1

A hydrophilic oligomer for use as a stabilising substance in the invention process was prepared using the following procedure. In a round-bottomed flask equipped with a stirrer and reflux condenser, 1044.1 parts of water and 1.64 parts of SLS and 0.59 parts of APS were mixed and heated to 85° C. 5 wt % of a pre-emulsified feed of 473.5 parts of MMA, 46.2 parts of MAA, 57.7 parts of AAEM, 238.5 parts of water, 9.3 parts of SLS and 15.6 parts of a CTA (3-mercaptopropionic acid) was added to the flask at 60° C. Subsequently the remaining monomer feed was added over a period of 1 hour. An initiator feed of 1.37 parts of APS dissolved in 141.1 parts of water was added over a period of 70 minutes. After completion of the initiator feed the reaction mixture was kept at 85° C. for 20 minutes before reducing the temperature to 60° C. The pH of the flask contents was increased to 8 using a mixture of 45.48 parts aqueous NH₃ (25 wt % in water) and 36.25 parts of water. A solution of 0.82 parts of sodium metabisulphite in 13.6 parts of water was fed to the flask over a period of 45 minutes and directly after the start of this feed a slurry of 0.78 parts of t-butyl hydroperoxide and 2.27 parts of water was added to the flask. This was repeated after 15 and 30 minutes after the start of the sodium metabisulphite feed. After completion of the sodium metabisulphite feed the reactor phase was cooled to 30° C. and filtered. The final product had a pH of 8.0 and a solids content of 30%. The weight average molecular weight of the hydrophilic oligomer HO1 was 12,000 g/mol.

### Preparation of a Single-Phase Macromonomer MM1 and MM2 [Step A)]

In a round-bottomed flask equipped with a stirrer, reflux condenser and two metal baffles positioned on opposite sides of the flask, 47.17 parts of HO1 (30% solids) was mixed with a preformed solution of Co4-MePhBF (0.006 parts for MM1, 0.0023 parts for MM2) and 14.15 parts of MMA at room temperature. After mixing for 1 hour at room temperature the emulsified mixture was diluted with 1196.2 parts of water and heated to 75° C. thereby forming a pre-emulsified mixture. At 75° C., 5.66 parts of an APS solution (2.5% in water pH 8.5) was added to the flask to start the polymerisation of the pre-emulsified mixture. The mixture was further heated to 85° C. and kept at 85° C. for 10 minutes. At this point a monomer feed consisting of a 566 parts of MMA (MM1) or 566 parts of n-BMA (MM2), and a separate APS initiator feed, comprising 108 parts of an APS solution (2.5% in water) and 9.43 parts of SLS (30% solution in water) at a pH of 8.5 was started. The monomer feed and separate initiator feed were added over a period of 240 minutes. Following the addition of the monomer feed the monomer feed tank was rinsed into the flask with 53.8 parts of water. The reaction mixture was kept at 85° C. for 90 minutes. The emulsion was cooled to room temperature and filtered.

The final macromonomer aqueous emulsion MM1 had a sediment content of ≦0.05%, a solids content of 30%, a pH of 8.5, a viscosity of 10 mPa·s (at 25° C.) and a particle size of 60 nm. The weight average molecular weight of macromonomer MM1 was 45,000 g/mol and the calculated Tg was 105° C.

The final macromonomer aqueous emulsion MM2 had a sediment content of ≦0.05%, a solids content of 30%, a pH of 8.5, a viscosity of 10 mPa·s (at 25° C.) and a particle size of 63 nm. The weight average molecular weight of macromonomer MM2 was 45,000 g/mol and the calculated Tg was 20° C.

### Preparation of a Sequential Macromonomer MM3 [Step A)]

In a round-bottomed flask equipped with a stirrer, reflux condenser and two metal baffles positioned on opposite sides of the flask 47.17 parts of HO1 was mixed with a preformed solution of 0.003 parts of Co4-MePhBF and 14.15 parts of MMA at room temperature. After mixing for 1 hour at room temperature the emulsified mixture was diluted with 1196 parts of water and heated to 75° C. thereby forming a pre-emulsified mixture. At 75° C., 5.66 parts of an APS solution (2.5% in water) was added to the flask to start the polymerisation of the pre-emulsified mixture and was further heated to 85° C. and kept at 85° C. for 10 minutes. At this point a first vinyl monomer feed consisting of 339 parts of MMA and a separate APS initiator feed, comprising 65 parts of an APS solution (2.5% in water) and 5.66 parts of SLS (30% solution in water) at a pH of 8.5, was fed to the flask over 150 minutes. After completion of the vinyl monomer feed the reaction was kept at 85° C. for 60 minutes. After 60 minutes a second vinyl monomer feed comprising 226 parts of n-BMA and a separate APS initiator feed, comprising 43 parts of an APS solution (2.5% in water pH=8.5) and 3.77 parts of SLS (30% solution in water) at a pH of 8.5, was fed to the flask over 90 minutes. Following the addition of the second vinyl monomer feed the vinyl monomer feed tank was rinsed with 53.8 parts of water into the flask. The polymerisation mixture was kept at 85° C. for 90 minutes. The emulsion was cooled to room temperature and filtered. The final macromonomer aqueous emulsion typically had a sediment content of ≦0.05%, a solids content of 30%, a pH of 8.5, a viscosity of 10 mPa·s and a particle size of 70 nm. The weight average molecular weight of macromonomer MM3 was 64,000 g/mol. The MFFT of macromonomer MM3 emulsion was 53° C. The calculated Tg of the first stage was 105° C. and of the second stage was 20° C.

Preparation of a Macromonomer MM4 with a Gradient Morphology [Step A)]

In a round-bottomed flask equipped with a stirrer, reflux condenser and two metal baffles positioned on opposite sides of the flask 47.17 parts of HO1 was mixed with a preformed solution of 0.003 parts of Co4-MePhBF and 14.15 parts of MMA at room temperature. After mixing for 1 hour at room temperature the emulsified mixture was diluted with 1196 parts of water and heated to 75° C. thereby forming a pre-emulsified mixture. At 75° C., 5.66 parts of an APS solution (2.5% in water) was added to the flask to start the polymerisation of the pre-emulsified mixture before further heating to 85° C. and keeping it at 85° C. for 10 minutes. At this point a first vinyl monomer feed comprising 339 parts of MMA and a separate APS initiator feed comprising 108 parts of an APS solution (2.5% in water pH=8.5) and 9.43 parts of SLS (30% solution in water) at a pH of 8.5, was fed to the flask over 240 minutes. At the same time a second vinyl monomer feed comprising 226 parts of BMA was fed to the first vinyl monomer feed over 240 minutes. Following the addition of the second vinyl monomer feed the vinyl monomer feed tank was rinsed with 53.8 parts of water into the flask. The polymerisation mixture was kept at 85° C. for 90 minutes. The emulsion was cooled to room temperature and filtered. The final macromonomer aqueous emulsion typically had a sediment content of ≦0.05%, a solids content of 30%, a pH of 8.5, a viscosity of 10 mPa·s and a particle size of 66 nm. The weight average molecular weight of the macromonomer MM4 was 56,000 g/mol. The MFFT of the macromonomer MM4 emulsion was 73° C. Polymers with a gradient morphology have a continuous variation in Tg.

### Preparation of Graft Copolymer (A) VG1 [Step B)]

In a round-bottomed flask equipped with a stirrer, reflux condenser and two metal baffles positioned on opposite sides of the flask 260.43 parts of MM1 (30% solids), 5.27 parts of SLS and 540.89 parts of water were mixed. The pH was checked and if necessary adjusted to pH=8.5. 33.05 parts of nBA and 2.11 parts of AA were charged to the reactor phase. The mixture was heated to 75° C. At this temperature 4.5 parts of a 3.5% APS solution in water at pH=8.5 was added. The reaction mixture was further heated to 85° C. At this temperature the reaction mixture was stirred for 10 minutes to form the graft copolymer VG1. The procedure was repeated with MM2, MM3 and MM4 to give VG2, VG3 and VG4 respectively. The calculated Tg of the polymeric backbone was −50° C.

### Preparation of Vinyl Polymer (B) in the Presence of Vinyl Graft Copolymer (A) [Step C)]

### EXAMPLE 1

An emulsified monomer feed was prepared comprising 269.2 parts of water, 29.89 parts of SLS and 668.07 parts of nBA. An initiator feed comprising 100.46 parts of a 3.5% APS solution in water at pH=8.5 and 5.86 parts of SLS was prepared. The monomer feed and initiator feed were added to all of the VG1 prepared in step b) above prepared as described above at 85° C. over 2 hours. The reaction mixture was kept at 85° C. for 15 minutes after completion of both feeds. A shot of 4.68 parts of 30% solution of tBHPO was added to the reaction mixture. At the same time a feed was started comprising 28.13 parts of a 2.5% isoascorbic acid solution in water at a pH of 8.5. This feed was added over 15 minutes. The reaction mixture was kept at 85° C. for another 30 minutes. After cooling to room temperature the pH was adjusted to 8.0 to 8.5 with 12.5% ammonia solution. The calculated Tg of vinyl polymer (B) was −54° C. The procedure was repeated with VG2, VG3 and VG4 to give examples 2, 3 and 4 respectively. The results are shown in Table 1 below.

TABLE 1

| | Viscosity | Particle size | | |
|---|---|---|---|---|
| pH | mPa · s, 25° C. | nm | Sediment % | Solids % |
| Example 1 | 8.0 | 120 | <0.05 | 40 |
| Example 2 | 8.3 | 126 | <0.05 | 40 |
| Example 3 | 8.0 | 169 | <0.05 | 40 |
| Example 4 | 8.0 | 152 | <0.05 | 40 |

### COMPARATIVE EXAMPLE (POLY BA)

In a round-bottomed flask equipped with a stirrer and reflux condenser 812.24 parts of water were charged and heated to 60° C. At 60° C. a 5% of an emulsified feed comprising 202 parts of water, 38.97 parts of SLS and 779.35 parts of nBA was added to the flask. At 65° C. 4.5 parts of an APS solution (3.5% in water) was added. The temperature was increased to 85° C. At this temperature the mixture was mixed for 5 minutes before the remaining 95% of the emulsified feed together with an initiator feed comprising 111.34 parts of an APS solution (3.5% in water) and 6.50 parts of SLS were charged to the flask over 2 hours. After completion of both feeds the reaction mixture was kept at 85° C. for 15 minutes. Additionally, a shot of 5.2 parts of 30% solution of tBHPO was added to the reaction mixture. At the same time a feed was started comprising 31.17 parts of a 5% isoascorbic acid solution in water. This feed was added in 15 minutes. The reaction mixture was kept at 85° C. for another 30 minutes. After cooling to room temperature the pH was adjusted to 7.6 with 12.5% ammonia solution. The final product had a sediment content of 0.05%, a solids content of 39%, a pH of 7.6, a viscosity of mPa·s (at 25° C.) and a particle size of 180 nm. The calculated Tg was −54° C.

### Adhesion Tests

For the bond strength measurements the example compositions were applied to a paper test chart. A layer of 24 μm wet emulsion was applied and dried for 30 seconds at 80° C. The coated side of the paper test chart was placed in contact with a range of uncoated substrates to give a laminate and the laminate was bonded by rolling twice over the laminate using a 10 kg roller. The laminates tested were Paper—PET, Paper—50 MB-210, Paper—Metal and Paper—Glass. The laminates were peeled apart using a Hounsfied tensile strength apparatus and the bond strength was measured in g/inch and converted to g/cm. The results are given below in Table 2.

TABLE 2

| | Example 1 | | Example 2 | | | Example 3 | | |
|---|---|---|---|---|---|---|---|---|
| | g/inch | g/cm | g/inch | g/cm | T | g/inch | g/cm | T |
| Paper/PET | 125 | 318 | 134 | 340 | T3 | 119 | 302 | — |
| Paper/ | 87 | 221 | 138 | 653 | — | 257 | 653 | — |
| 50MB-210 | | | | | | | | |
| Paper/Metal | 87 | 221 | 211 | 536 | T4 | 654 | 1661 | T4 |
| Paper/Glass | 444 | 1128 | 338 | 859 | T3 | 692 | 1787 | T4 |

| | |
|---|---|
| | Comparative |
| Example 4 | Example |

| | g/inch | g/cm | T | g/inch | g/cm |
|---|---|---|---|---|---|
| Paper/PET | 196 | 498 | — | 207 | 526 |
| Paper/50MB-210 | 162 | 411 | — | 241 | 612 |
| Paper/Metal | 394 | 1001 | T4 | 289 | 734 |
| Paper/Glass | 523 | 1328 | T4 | 365 | 927 |

T = Degree of transfer of coating from paper to uncoated substrate;
scale: 5 = total transfer to 1 = no transfer.
No T value = substrate broken.

### Fouling

To determine the degree of fouling during the preparation of the examples the fouling of the reaction flask walls, baffles and stirrer was visually inspected and compared with the fouling observed during the preparation of the Comparative Example. The results are shown below in Table 3.

TABLE 3

Degree of fouling

| | Flask | Baffles | Stirrer |
|---|---|---|---|
| Comparative | Medium | Medium-Lots | Excessive |
| Example | | | |
| Example 1 | Little | Little | Little |
| Example 2 | Little | Little | Little |
| Example 3 | Little | Little | Little |
| Example 4 | Little | Little | Little |

1. An aqueous composition comprising at least one vinyl graft copolymer (A) and at least one vinyl polymer (B) obtained by a process comprising steps:
a) polymerising at least one vinyl monomer to obtain at least one macromonomer with a Tg¹≧15° C.;
b) polymerising i) 60 to 5 wt % of at least one vinyl monomer in the presence of ii) 40 to 95 wt % of the macromonomer prepared in step a) to form a polymeric backbone of said vinyl graft copolymer (A) and where i) and ii) add up to 100%;
c) polymerising iii) 95 to 50 wt % of at least one vinyl monomer in the presence of iv) 5 to 50 wt % of the vinyl graft copolymer (A) prepared in step b), to form said vinyl polymer (B);
where iii) and iv) add up to 100%; and
where vinyl polymer (B) has a Tg² lower than the Tg¹ of the macromonomer.

2. An aqueous composition according to claim 1 where the ratio of vinyl graft copolymer (A) to vinyl polymer (B) is in the range of from 45:55 to 5:95.

3. An aqueous composition according to claim 1, where the Tg² of vinyl polymer (B) is in the range of from −55 to 35° C.

4. An aqueous composition according to claim 1, where the difference in Tg between the Tg² of vinyl polymer (B) and the Tg¹ of the macromonomer is Tg¹−Tg²≧15° C.

5. An aqueous composition according to claim 1, where the difference in Tg between the Tg¹ of the macromonomer and Tg³ of the polymeric backbone is Tg¹−Tg³≧20° C.

6. An aqueous composition according to claim 1, where the macromonomer comprises 0 to 60 wt % of vinyl monomers bearing water-dispersing groups.

7. An aqueous composition according to claim 1, where the macromonomer is prepared by emulsion, suspension, solution or bulk polymerisation.

8. An aqueous composition according to claim 1, where the polymeric backbone is prepared by emulsion, suspension, solution or bulk polymerisation.

9. An aqueous composition according to claim 1, where vinyl polymer (B) is prepared by emulsion or suspension polymerisation.

10. An aqueous composition according to claim 1, where the macromonomer, when obtained by catalytic chain-transfer polymerisation, is a macromonomer of Formula (1):
CH₂═C(R³)—CH₂—[X]ₙ (1)
where R³=optionally substituted aryl, —C(O)OR⁴ or —C(O)NR⁴R⁵;
R⁴═—H, —CH₃ or optionally substituted C₁ to C₁₆ alkyl, cycloalkyl, aryl, (alkyl)aryl;
R⁵—H, —CH₃ or optionally substituted C₁ to C₁₆ alkyl, cycloalkyl, aryl, (alkyl)aryl;
X=residue of an olefinically unsaturated monomer(s);
n=an integer in the range of from 2 to 1000.

11. An aqueous composition according to claim 1, where the macromonomer is prepared by the use of diarylethene.

12. An aqueous composition according to claim 1, where the macromonomer is prepared by a high temperature polymerisation process.

13. A process for the preparation of an aqueous composition according to claim 1, said process comprising steps:
a) polymerising at least one vinyl monomer to obtain a macromonomer with a Tg¹≧15° C.;
b) polymerising i) 60 to 5 wt % of at least one vinyl monomer in the presence of ii) 40 to 95 wt % of the macromonomer prepared in step a) to form a polymeric backbone of said vinyl graft copolymer (A) and where i) and ii) add up to 100%;
c) polymerising iii) 95 to 50 wt % of at least one vinyl monomer in the presence of iv) 5 to 50 wt % of the vinyl graft copolymer (A) prepared in step b), to fonn said vinyl polymer (B);
where iii) and iv) add up to 100%; and
where vinyl polymer (B) has a Tg² lower than the Tg¹ of the macromonomer.

14. A process for the preparation of an aqueous composition according to claim 1, said process comprising steps:
a) polymerising vinyl monomers comprising ≧1 wt % of vinyl monomers providing anionic water-dispersing groups to obtain a macromonomer with a Tg¹≧15° C.;
b) polymerising i) 60 to 5 wt % of at least one vinyl monomer in the presence of ii) 40 to 95 wt % of the macromonomer prepared in step a) at a pH≦6.5 to form a polymeric backbone of said vinyl graft copolymer (A) and where i) and ii) add up to 100%;
c) polymerising iii) 95 to 50 wt % of at least one vinyl monomer in the presence of iv) 5 to 50 wt % of the vinyl graft copolymer (A) prepared in step b), to form said vinyl polymer (B);
where iii) and iv) add up to 100%; and
where vinyl polymer (B) has a Tg² lower that the Tg¹ of the macromonomer.

15. A coating obtained from an aqueous composition according to claim 1.

16. A printing ink comprising an aqueous composition according to claim 1.

17. An overprint lacquer comprising an aqueous composition according to claim 1.

18. An adhesive comprising an aqueous composition according to claim 1.
